(19) United States
(12) Patent Application Publication
(10) Pub. No.: US 2009/0256375 A1
(43) Pub. Date: Oct. 15, 2009

(54) METHOD AND APPARATUS FOR MOBILE, ON-SITE DEGAUSSING AND PHYSICAL E-COMMERCE DESTRUCTION

(76) Inventor: Robert A. HASKINS, Quakertown, PA (US)

Correspondence Address: CHARLES N. QUINN;FOX ROTHSCHILD LLP, 2000 MARKET STREET, 10TH FLOOR, PHILADELPHIA, PA, 19103, US

(21) Appl. No.: 12/102,087

(22) Filed: Apr. 14, 2008

(51) Int. Cl. B60P 3/14; H01F 13/00; B02C 17/00; B60P 1/00; H04N 7/18; G08B 23/00

(52) U.S. Cl. 296/24.32; 361/149; 241/83; 414/539; 348/143; 340/426.1; 241/24.1

(57) ABSTRACT

The present invention relates to a method and apparatus for destroying, on site, electronic and electric equipment and media and the information contained thereon. More specifically, the present invention relates to an apparatus and method for removing information stored on electronic and electric equipment and media by degaussing and shredding the physical hardware containing the information. Each of the degausser and the shredder are contained within a mobile vehicle such that the scrap electronic and electric equipment and media may be destroyed and stored within targeted receptacles. Moreover, the mobile vehicle of the present invention is adapted to move from one location to another such that the method of destroying the electronic and electric equipment and media may be utilized on-site at the facility of a business owner, thereby, eliminating any risk associated with compromising the confidentiality of the information.

### FIELD OF THE INVENTION

The present invention relates to a method and apparatus for destroying, on site, electronic and electric equipment and media and the information contained thereon. More specifically, the present invention relates to a mobile apparatus and method for removing information stored on electronic and electric equipment and media by degaussing and shredding the physical hardware containing the magnetic storage media.

### BACKGROUND OF THE INVENTION

Maintaining the security of confidential information in an increasingly paperless environment is of primary importance. One known method of storing and securing such information is through magnetic storage media, e.g. computer hard drives, floppy disks, hard disks, magnetic tape, and the like. Confidential information, e.g. financial information, company trade secrets, top level government security information, etc. may be stored on this magnetic storage media with ease such that these methods are relatively ubiquitous. The ability to prevent unauthorized personnel from reading, viewing or hearing such stored data is, thereby, necessary. For example, with governmental security information, the ability for unauthorized personnel to read, view or hear top level governmental information could compromise national security and risk the lives the thousands. Accordingly, it is imperative that this information be kept secure during storage and thereafter.

Currently known storage methods, however, are rapidly evolving. Technological advances and the speed at which many computer systems and media storage means are rendered obsolete makes repairing the storage media uneconomical. Most computers, hardware and other storage media are simply discarded after sufficient use or if there is a malfunction. Prior to discarding this equipment, however, it is extremely important that the stored magnetic media be completely erased. This is especially true with magnetic storage media containing confidential information for the reasons discussed above.

Magnetic storage media are known to be completely erased by a technique called degaussing. Specifically, magnetic storage devices use a plurality varying patterns of magnetization on a magnetizable material to store data in a form commonly referred to as “non-volatile memory.” The information is stored by changing the magnetic alignment of very small areas of a magnetic surface, termed “magnetic domains”, to be within a direction of an applied magnetic field. The stored information may, thereby, be disrupted or eliminated by simply rearranging the magnetic alignment within each magnetic domain. Degaussing accomplishes such rearrangement by applying external magnetic fields of opposite polarity across the magnetized material. These external magnetic fields may be created by applying an alternating field, i.e. an alternating current, across the magnetized material with an initially high amplitude that is gradually reduced over time. Alternatively, the external magnetic fields may be created by applying a unidirectional field, i.e. direct current, across the magnetizable material wherein the unidirectional field is supplied by a permanent magnet. In either case, the magnetic field rearranges the magnetic domains of the storage material and completely erases the stored information.

Degaussing, however, in many instances may not be enough. An noted above, the continual evolution of storage media produces more complicated hardware wherein degaussing these pieces of equipment, in some instances, is insufficient as the sole means to eliminate the stored information. Physical destruction of the magnetic media may be provided either as an alternative or in conjunction with degaussing. However, because many such storage media may contain hazardous and toxic materials posing significant environmental risks; physical destruction is preferably performed in a controlled environment wherein potentially hazardous and toxic materials may be contained. It is, therefore, advantageous to degauss and destroy the magnetic storage media at a central location.

For many businesses and organizations, the cost of purchasing the necessary equipment for such electronic and electrical equipment and media destruction is prohibitive. In such instances, companies usually hire an outside source to eliminate the magnetically stored information and shred the physical hardware. To date, these outside sources maintain the proper degaussing and shredding equipment at an off-site facility, i.e. at a location other than that of the business. The businesses/organizations must, therefore, ship the scrap materials to the off-site facility for destruction. This is arrangement may compromise the confidential information. Most notably, when the information contained within the “scrap” electronic and electrical equipment and media contains confidential information, the confidentiality of the information may be compromised once it leaves the original facility, i.e. in transit to the “off-site” facility, at the “off-site” facility, etc. In the case where the storage media contains governmental or classified information, this could potentially have major implications on national security.

Based on the foregoing, an apparatus and method is desirable for conveniently and completely destroying magnetically stored data and physical hardware without potentially compromising the confidentiality of the data stored thereon.

Moreover, there is a need for an apparatus and method for on-site secure destruction of magnetically stored data and the physical hardware, wherein “on-site” refers to the facility of the business desiring destruction of the stored data/equipment.

There is also a need for an apparatus and method for a mobile apparatus and method of destroying magnetically stored data and the physical hardware so as to relocate the necessary equipment to an on-site facility of a company or business.

This invention addresses the foregoing needs.

### SUMMARY OF THE INVENTION

This invention relates to a method and apparatus for destroying, preferably on site, electronic and electric equipment and media and the information contained thereon. More specifically, the invention relates to an apparatus and method for removing information stored on electronic and electric equipment and media preferably by degaussing and shredding the physical hardware containing the information. Each of the degausser and the shredder are preferably contained within a mobile vehicle such that the scrap electronic and electric equipment and media may be destroyed and stored within targeted receptacles. Moreover, the mobile vehicle of the invention is preferably adapted to move from one location to another such that the method of destroying the electronic and electric equipment and media may be utilized on-site at the facility of a business owner, thereby eliminating any risk associated with compromising the confidentiality of the information.

The apparatus of the invention preferably includes of a vehicle, e.g. a tractor trailer adapted for highway travel and having an enclosed openable bed as a part thereof. An electrical generator, mounted within an interior portion of the bed, preferably provides electricity for the interior of the openable bed. A workbench is also positioned within the bed of the vehicle and is adapted to facilitate with the breakdown of larger storage media/or equipment. At least one degausser is preferably mounted within the bed and is electrical communication with the generator. The degausser is of a sufficient electromagnetic flux to completely eliminate all stored information on the storage media/equipment. The strength of the electromagnetic flux is, therefore, preselected based upon the nature and level of sensitivity of any information that had been stored or handled by the scrapped electronic and electrical equipment. In one embodiment, the degausser is a conveyer type degausser that receives the scrap storage media or equipment and passes it through the degausser.

Also preferably contained within the bed of the vehicle is a shredder. The shredder, preferably a Hammermill-type shredder, is in electrical communication with the generator and preferably receives the scrap storage media/equipment after it has been degaussed. In one embodiment, the shredder preferably receives the degaussed storage media by way of a second conveyer system. More specifically, the second conveyer system receives the degaussed storage media and equipment directly from the degausser or from an operator who physically removes the degaussed media/equipment to the conveyer system. In a further embodiment, the shredder receives the degaussed media/equipment directly from an operator, who transfers the scrap material from the degausser to the shredder.

Once within the shredder, the degaussed storage media and equipment is shredded by a plurality of hammers or cutting instruments rotating about the horizontal axis of a rotor. The hammers or cutting instruments destroy the storage media and equipment such that it is no longer usable. The shredded media and equipment is then preferably suctioned out of the shredder by a third conveyer system, which is preferably comprised of a vacuum type system. Within the third conveyer system heavier pieces of the shredded media/equipment is deposited into an appropriate receptacle. Lighter, airborne pieces, however, are redirected along an air filtration duct to an air filtration system. The air filtration system traps the air borne particles therein such that the air exhausted from the third conveyer system is substantially free from any particles of the shredded media/equipment.

The receptacles receiving the heavier pieces of equipment are removably mounted to the open bed such that, once full, they may be removed from the bed. More specifically, the receptacle may be mounted on a roller track-type system wherein the receptacle may slide over a plurality of rollers into position beneath the third conveyer or slide away from the third conveyer system when full. The vehicle or openable bed of the vehicle may also be equipped with a lift mechanism for raising and lowering the receptacle into and out of the open bed of the vehicle. To this end, full receptacles may be removed from the vehicle for proper disposal and empty receptacles may be loaded into the vehicle as replacements.

Both the exterior and interior of the vehicle may also be equipped with a video and/or audio surveillance system. These systems may be provided within the vehicle to monitor and record the interior of vehicle and maintain the security therewithin. Similarly, these systems may be provided on an exterior surface of the vehicle to monitor and record the outside of the vehicle for security purposes.

The vehicle may be equipped with an alarm system mounted on the vehicle. The alarm system may be an audible alarm, an electronic alarm or any other similar type of security alarm system that sends a signal from the vehicle to a second location, which may be remote from the vehicle, where an operator may be notified. The alarm signal may be activated at any time, but is preferably activated during non-operation of the vehicle and the equipment above. Most preferably, the alarm sends a signal upon a signaling event, which may be manual activation, unauthorized motion within the bed of the vehicle, unauthorized motion in the area immediately outside of the vehicle; equipment failure; unauthorized personnel within the vehicle; unauthorized personnel around an exterior of the vehicle, or the like.

In one of its aspects this invention provides mobile apparatus for destroying scrap electronic and electrical equipment and media at selected dispersed sites where the apparatus includes a vehicle adapted for highway or off-highway travel and having an enclosed openable bed as a part of the vehicle, an electrical generator mounted on the vehicle, at least one degausser mounted within the vehicle bed, an electrical bed, an electrical communication with the generator and providing electro-magnetic flux of preselected strength based upon the nature and level of sensitivity of any information that had been stored or handled by the now scrapped electronic and electrical equipment, in order to destroy such information; and a shredder for shredding the degaussed scrap electronic and electrical equipment and media; mounted within the bed of the vehicle and an electrical communication with the generator.

The vehicle is preferably a tractor trailer.

The vehicle further preferably includes a workbench mounted within the vehicle bed where the workbench facilitates worker disassembly of scrap electronic and electrical equipment and media, as needed, prior to degaussing and/or shredding.

The generator is preferably a 480 volt, 3 phase generator producing at least about 40 kilowatts of power.

The degaussers are adapted to completely erase the magnetically stored memory of the scrapped electronic and electrical equipment and media being destroyed.

In another of its aspects this invention provides a process for destroying scrap electronic and electrical equipment and media at selected geographically separated sites, where the process includes providing a vehicle that is adapted for highway and off road travel and has an enclosed openable bed as a part thereof; with an electrical generator mounted on the vehicle The vehicle includes at least one degausser, for degaussing electronic and electrical equipment and media, mounted within the vehicle bed and being in electrical communication with the generator. The vehicle includes at least one shredder being mounted within the vehicle bed wherein the shredder is in electrical communication with the generator and receives scrap electronic and electrical media from the least one degausser after degaussing is complete; feeding scrap electronic and electrical equipment and media into the at least one degausser. The process proceeds with degaussing the electronic and electrical equipment and media to a point where the electronically stored data contained thereon is destroyed. The process continues by feeding the degaussed electronic and electrical equipment and media into the shredder carried by the vehicle and thereafter shredding the degaussed electronic and electrical equipment and media to a point where the degaussed electronic and electrical equipment and media is physically destroyed.

In yet another one of its aspects this invention provides a process for destroying scrap electronic and electrical equipment and media at selected geographically separated sites involving the steps of providing a vehicle that is adapted for highway travel and has an enclosed openable bed as a part thereof, with an electrical generator mounted on the vehicle. At least one degausser for degaussing electronic and electrical equipment and media mounted is within the bed and in electrical communication with the generator. At least one shredder is mounted within the truck bed where the shredder is in electrical communication with the generator and receives scrap electronic and electrical media from the at least one degausser after degaussing is complete and wherein the steps of the invention further include feeding scrap electronic and electrical equipment and media into the at least one degausser; degaussing the electronic and electrical equipment and media; feeding the degaussed electronic and electrical equipment into the shredder; shredding the degaussed electronic and electrical equipment and media; conveying the shredded scrap electronic and electrical equipment and media from the shredder to at least one selected receptacle wherein the receptacle is removably mounted on the vehicle; optionally recording activity within the enclosed bed via first video and audio recorder system mounted on the vehicle; sending a signal from an alarm system mounted on the vehicle wherein the signal is sent in response to occurrence of a signaling event selected from the group consisting of manual activation, unauthorized motion within the bed for the vehicle, unauthorized motion in the area immediately outside of the vehicle, equipment failure, unauthorized personnel within the vehicle, and unauthorized personnel around the exterior of the vehicle; and upon completion of the degaussing and shredding of the electronic and electrical equipment and media at that site, moving the vehicle to a second site where degaussing and shredding of electrical and electronic equipment and media is required.

In still another one of its aspects this invention provides mobile apparatus for destroying scrap electronic and electrical equipment and media at selected sites where the apparatus includes a vehicle adapted for highway travel and having an enclosed openable bed as a part thereof; an electrical generator mounted on the vehicle; at least one degausser mounted within the vehicle bed and in electrical communication with the generator and being capable of producing electro-magnetic flux that is of a preselected level based upon the nature and level of sensitivity of any information that had been stored or handled by the now scrapped electronic and electrical equipment; a first conveyor system mounted within the at least one degausser wherein the conveyor system automatically feeds the scrap electronic and electrical equipment and media into and through the degausser; a shredder for shredding the scrap electronic and electrical equipment and media that is mounted within the bed of the vehicle and is in electrical communication with the generator, wherein the shredder receives scrap electronic and electrical media from the degaussers after degaussing is completed by way of the second conveyor system; and a receptacle removably mounted on the vehicle for receiving shredded scrap electronic and electrical equipment and media from the shredder.

In still another one of its aspects this invention provides mobile apparatus for destroying scrap electronic and electrical equipment and media at selected sites where the apparatus includes a vehicle adapted for highway travel and having an enclosed openable bed as a part thereof; an electrical generator mounted on the vehicle; at least one degausser mounted within the bed and in electrical communication with the generator and being capable of producing electromagnetic flux that is of preselected strength based on the nature and level of sensitivity of any information that had been stored or handled by the scrap electronic and electrical equipment in order to destroy any electrical information encoded thereon; a first conveyor system mounted within the at least one degausser wherein the conveyor system automatically feeds the scrap electronic and electrical equipment and media into and through the degausser; a shredder for shredding the scrap electrical and electronic equipment and media that is mounted within the bed of the vehicle and is electrical communication with the generator, where the shredder receives scrap electronic and electrical media from the degausser(s) after degaussing is complete by way of the second conveyor system; a receptacle removably mounted on the vehicle wherein the receptacle receives shredded scrap electronic and electrical equipment and media from the shredder after degaussing; and a vacuum driven conveyor that separates lighter shredded electronic and electrical equipment and media from heavier shredded electronic and electrical equipment and media and conveys the heavier shredded electronic and electrical equipment and media into the receptacle from the shredder and conveys the shredded electronic and electrical equipment and media to an air filtration system.

### DETAILED DESCRIPTION OF THE FIGURES

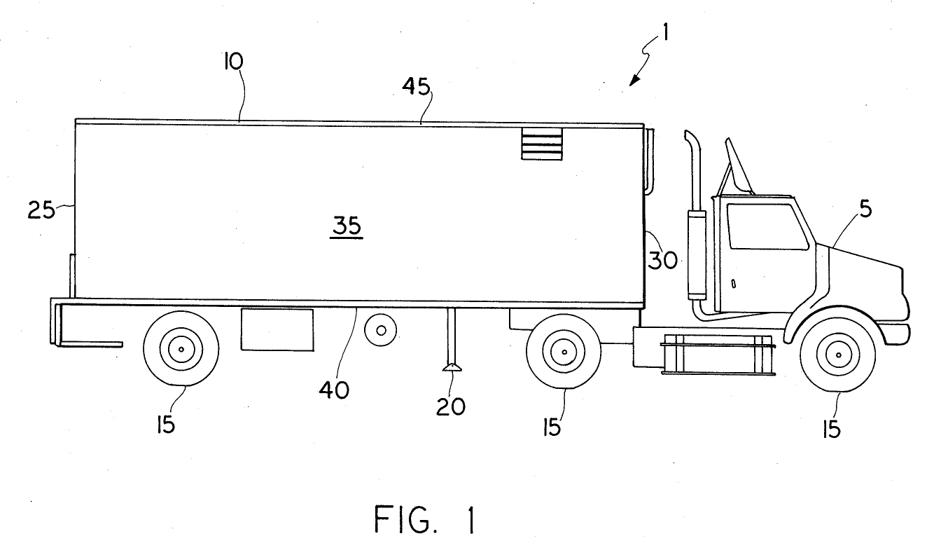

FIG. 1 is a right side view of one embodiment of a vehicle manufacturing the present invention.

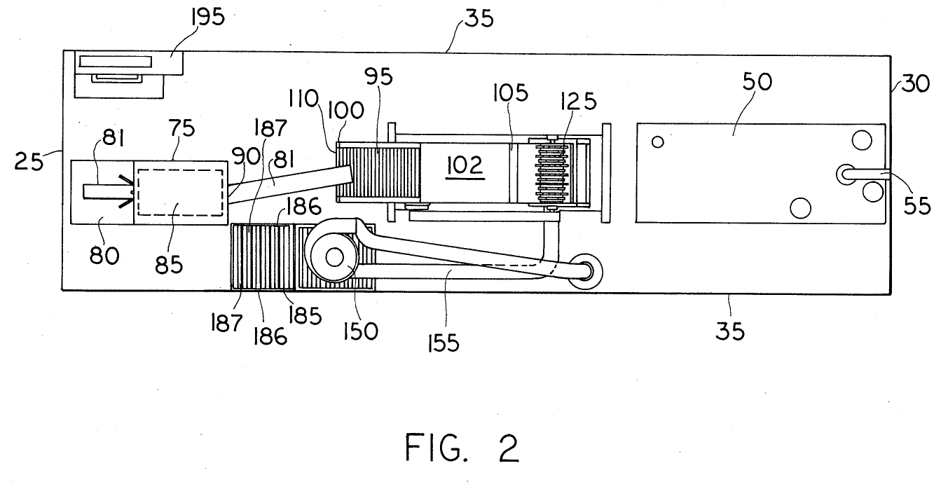

FIG. 2 is a top interior view of an openable bed of the vehicle of FIG. 1 wherein the open bed contains therein equipment for degaussing and shredding scrap electronic and electrical equipment and media.

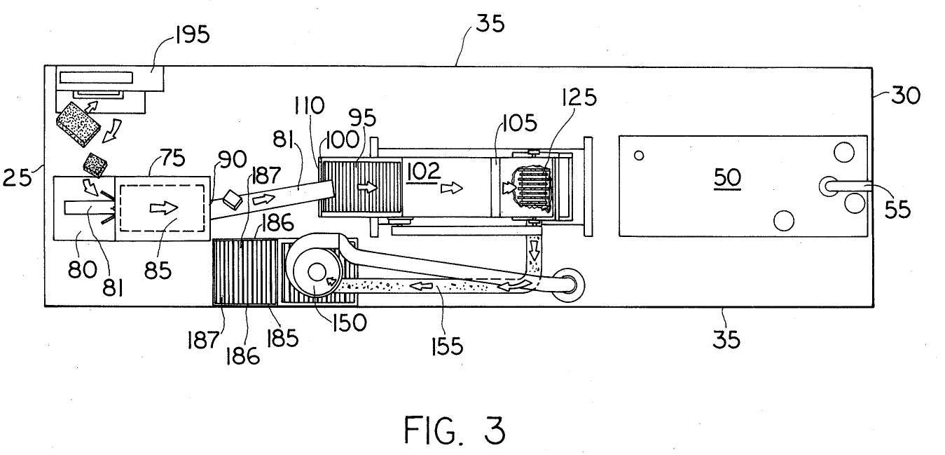

FIG. 3 is a top interior view of an openable bed of the vehicle of FIGS. 1 and 2 and illustrates the preferred path of scrap electronic and electrical equipment and media during degaussing and shredding.

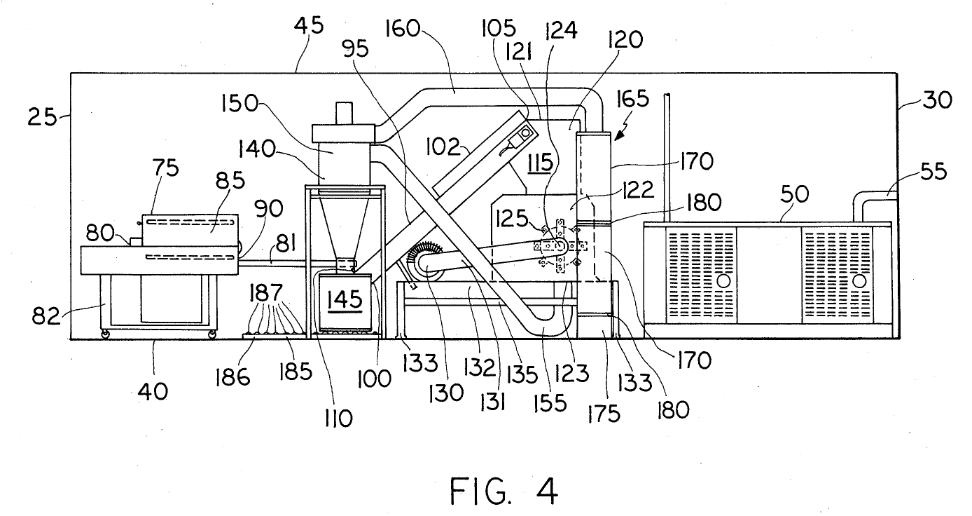

FIG. 4 is a side elevation of the bed of the vehicle of FIGS. 1, 2 and 3, with the side panels removed to expose the interior of the bed, wherein the bed contains equipment necessary to degauss and shred scrap electronic and electrical equipment and media.

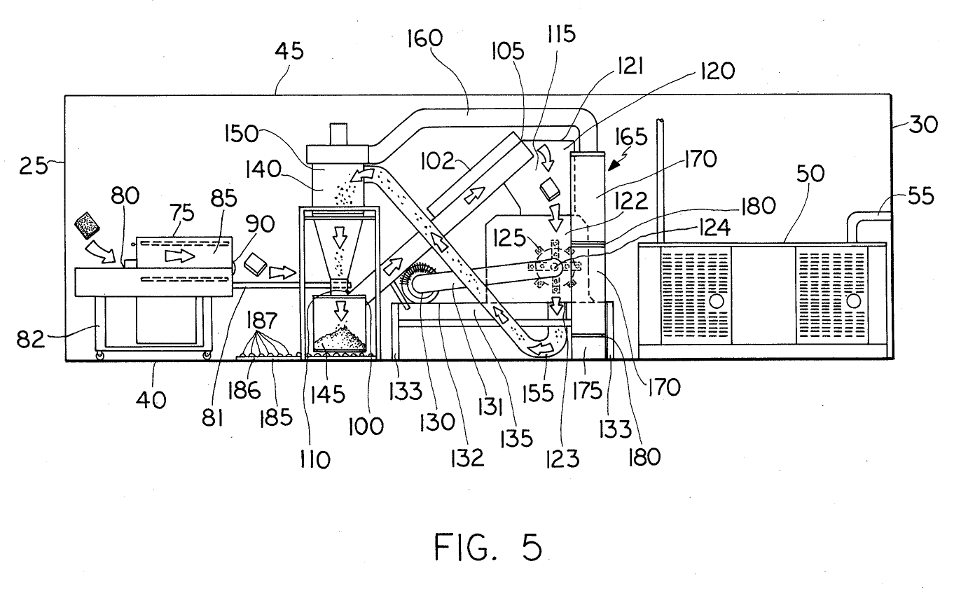

FIG. 5 is a side elevation of the bed of the vehicle of FIGS. 1 through 4 and illustrates the path traveled by scrap electronic and electrical equipment and media during degaussing and shredding therein.

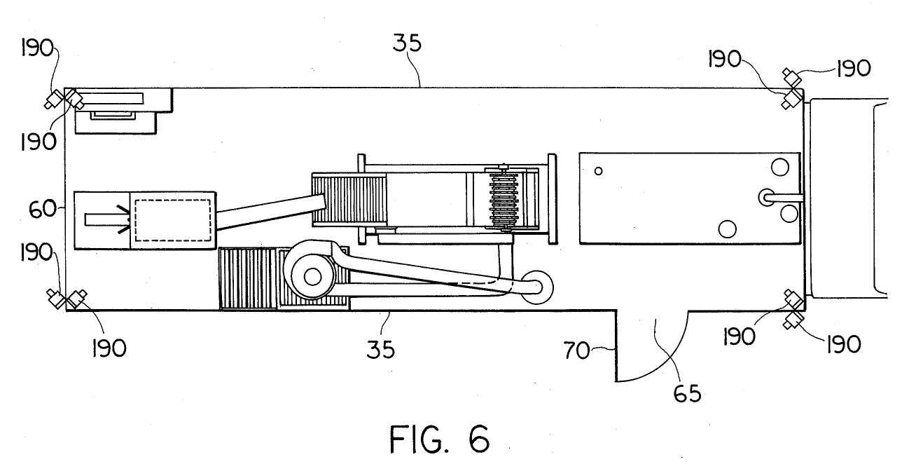

FIG. 6 is a top view of the vehicle of FIGS. 1 through 5 with the top panels removed to illustrate position and placement of components of the audio and video surveillance system on both the interior and exterior of the vehicle.

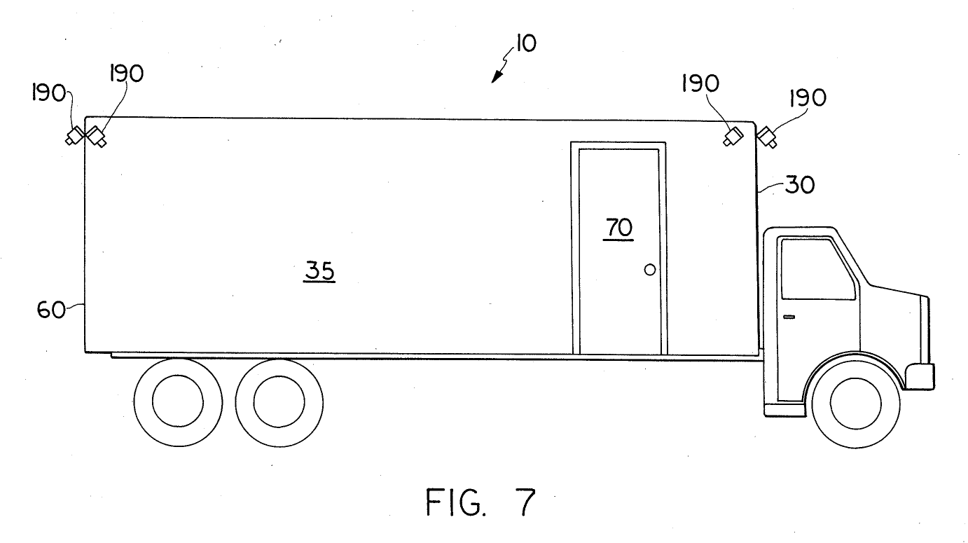

FIG. 7 illustrates a side view perspective of the exterior of the vehicle wherein the placement of the audio and video surveillance system are illustrated on the exterior of the vehicle.

### DETAILED DESCRIPTION OF THE INVENTION

This invention relates to methods and apparatus for destroying, on site, electronic and electric equipment and media and the information contained thereon. More specifically, the invention relates to an apparatus and method for removing information stored on electronic and electric equipment and media preferably first by degaussing and then shredding the physical hardware containing the electronic and electric equipment and media. The degausser equipment and the shredder are preferably contained within a mobile vehicle such that the scrap electronic and electric equipment and media may be destroyed on-site and then stored within targeted receptacles. Moreover, the mobile vehicle of the invention is adapted to move from one location to another such that the method of destroying the electronic and electric equipment and media may be utilized on-site at the facility of a business owner or government agency, thereby, eliminating risk associated with transporting confidential data containing magnetic media from one facility to another.

FIG. 1 illustrates one embodiment of a vehicle 1 for practice of the invention. The vehicle is illustrated as a tractor-trailer type vehicle preferably with a motor-containing cab 5 and a trailer 10. Both the cab 5 and trailer 10 are illustrated as containing a plurality of wheels 15 such that both the cab 5 and the tractor 10 are mobile. The trailer may preferably have one open end 25, two opposing side walls 35, a closed end 30, a floor 40, and a ceiling 45 such that the trailer 10 defines an enclosed space accessible only through open end 25. Open end 25 of trailer 10 is preferably equipped with a rear door (not illustrated), which may be opened or closed for entry and exit from trailer 10. In one embodiment, the rear door is preferably a garage-type door adapted to slide from a position parallel and adjacent to ceiling 45 to a position perpendicular to ceiling 45 and completely occluding open end 25. While FIG. 1 illustrates the trailer 10 coupled to the cab 5, the invention is not limited to this configuration. Rather, the trailer 10 may also be removable from the cab 5. To this end, trailer 10 may preferably be equipped with a stand 20, or other similar support means, for independently supporting trailer 10 on the ground.

Referring to FIGS. 6 and 7, the trailer, as discussed above, is not limited to three side walls and an open end 25. The open end 30 may, instead, be comprised of an end wall 60 dimensioned to be approximately the same size as the wall forming the closed end 30. A doorway size opening 65 may be integrally formed in one of the side walls 35 of the trailer and allows entry and exit to and from the interior of the trailer. Furthermore, a door 70 may be pivotally mounted to the doorway 65 so as to provide and prevent access to the interior of the trailer. In a further embodiment, a plurality of steps (not illustrated) may be engaged with the doorway 65 or some other aspect of the vehicle proximal to the doorway, so as to facilitate entry and exit therethrough.

In each of the above embodiments, the trailer 10 is adapted to contain therein one or more degaussing elements, one or more shredding elements, one or more storage elements, and one or more security elements all forming part of the invention. More specifically, the trailer 10 may contain therein any one or more degaussers, one or more shredders, a plurality of conveyer systems for conveying the scrap electronic and electrical equipment and media to the degaussers and shredders, a plurality of removable storage containers, an air filtration system, one or more workbenches, an internal and external monitoring system, and an alarm system. In a most preferred embodiment, the interior of the trailer 10 is equipped with one work bench for normally disassembling the magnetic storage media (where necessary), a generator, at least one degausser with a first conveyor passing storage media therethrough, a conveyer leading from the degausser to a shredder, a vacuum conveyor system leading from the shredder to a removable receptacle, and an air filtration system in fluid communication with the vacuum conveyor system. Additionally, the interior and exterior of the trailer are preferably equipped with an audio and video surveillance system and preferably an alarm system. The dimensions of the trailer 10 must therefore be sufficient to easily contain each of these elements, while not hindering their operation. In a most preferred embodiment, the trailer 10 may be approximately 28 feet in length by 8 feet in width by 8 feet in height.

The invention, however, is not limited to the above dimensions or even a tractor-trailer type vehicle. Rather, the invention may include any type of vehicle understood to accommodate the equipment discussed herein. To this end, the vehicle may be a van, bus, truck, or any similar vehicle.

Referring to FIGS. 2-5, contained within an interior of the trailer of the vehicle is preferably at least one generator 50. The generator 50 is preferably located at or near the closed end 30 of the trailer. The generator 50, however, is not limited to this location and may be placed anywhere within the interior or exterior of the vehicle or trailer so as to function in accordance with the description herein. When placed within the interior of the trailer, the generator 50 is connected to an exhaust pipe 55 that passes through at least one wall of the trailer. Preferably, the exhaust pipe 55 passes through the closed end 30 of the trailer and is affixed to the generator 50 such that exhaust fumes from the generator are redirected from the generator to an exterior side of the trailer or vehicle. Thus, the exhaust fumes associated with the generator 50 do not contaminate air within the vehicle or trailer. The generator 50 may be mounted to floor 40 of trailer 10 or may be contained within a protective casing (not illustrated) within trailer 10 wherein the structure of the generator is protected, while still easily accessible through one or more panel doors in the casing.

The generator may be comprised of any type of generator that is equipped to power each of the aspects of the invention discussed herein. In one embodiment, the generator is a diesel powered, 480 volt, 3 phase generator. Preferably, the generator has at least a 40 kilowatt output.

Contained within the trailer 10 is at least one optional workbench 195. Workbench 195 is a table-type work space with a flat top and at least four legs extending thereunder. The workbench 195 is adapted to facilitate the disassembly of larger storage media or equipment, e.g. hard drives, monitors, and the like, prior to degaussing. Accordingly, the workbench 195 is of a sufficient depth and width to support disassembly of the larger media or equipment by an operator. In a further embodiment, the workbench 195 may be adapted to store a plurality of tools commonly associated with disassembly of the storage media or equipment. For example, the workbench 195 may contain a plurality of drawers, shelves, or other organizational means to facilitate with the storage of these tools. Finally, in one embodiment, the workbench may be comprised of one or more electrical outlets in electrical communication with the generator. These outlets may be provided for electrical tools necessary for storage media/equipment disassembly and are in electrical communication with the generator by any of the means discussed below.

Also contained within the interior of the vehicle are one or more degaussers 75. The degaussers 75 are preferably removably mounted within the trailer such that they are preferably proximal to the open end 30 of the trailer 10. In one embodiment, as illustrated in FIGS. 4 and 5, the degaussers 75 are mounted to a wheeled cart 82, or similar mobile means, wherein the degaussers may be positioned in accordance with the above, but also repositioned to any location within the trailer 10. The invention is not constrained by this embodiment, however, and the degaussers may be secured to the trailer in a relatively fixed or immobile position or simply placed on the floor 40 of the trailer 10.

Each degausser 75 is in electrical communication with the generator 50. Specifically, the degaussers 75 are electrically connected to one or more terminals of the generator 50 through electrical wiring such that the generator provides electrical power to the degaussers 75. The electrical wiring (not illustrated) extending from the degausser 75 may be directly connected to the generator 50 such that the wires are simply placed on the floor 40 of the trailer 10 and directly place the degaussers 75 into electrical communication with the generator 50. Alternatively, the wiring may pass from the degaussers 75 to the generator 50 beneath the floor 40 or within the side walls 35 of the trailer such that the wiring is not exposed to wear and tear associated with the working environment of the interior of the trailer 10. In an embodiment, the generator 50 may be pre-wired within the trailer 10 such that a plurality of electrical outlets are positioned throughout the interior of the trailer 10. The degaussers 75 may be electrically coupled to the generator 50 by way of the one or more plurality of outlets. Accordingly, with this approach, the degaussers 75 may be repositioned to any location within the trailer that is proximal to one or more outlets. This method of electrically coupling an aspect of the invention to the generators 50 is not limited to the degausser but is also applicable to all aspects of the invention requiring electrical communication with the generator.

The degaussers 75 may be any degaussers 75 of sufficient power known in the art for erasing the contents of storage media, as contemplated herein. In accordance with the above, the degaussers 75 of the invention may be any embodiment of a degausser that eliminates the magnetic domains on a magnetic media by rearranging the magnetic alignment within each domain. These degaussers 75 may include any device applying one or more external magnetic fields of opposite polarity across the magnetized material, to include alternating fields associated with an alternating current and/or unidirectional fields associated with a direct current. The type degaussers 75 of the invention may, thereby, be selected based on a level of electromagnetic flux desired, as measured by either Oersted units of coercitivity or Gauss units, the nature of the material contained on the magnet storage media, and level of sensitivity of any information stored on the storage media. Accordingly, the strength of the degaussers may vary, depending on the circumstances. While not intended to be bound by theory, in one embodiment, the degaussers of the invention may provide a magnetic flux density to erase magnet storage media with units of coercivity between 350 Oe and approximately 5,000 Oe wherein the magnetic fields generated by the degausser are entirely contained within the degaussers 75. In a more preferred embodiment the degaussers of the invention may provide a magnetic flux density to erase storage media with units of coercivity between 750 Oe and approximately 5,000 Oe.

In one embodiment, the degaussers 75 of the invention may be equipped with a conveyor system for receiving and conveying the storage media therethrough. This conveyor system may be a belt feeder type conveyer system wherein a belt is continuously rotated about one or more axes such that the storage media may be continuously received and passed through the degaussers. Referring to FIGS. 3 and 5, the memory containing storage media may be placed into a first end 80 of the degausser wherein the belt feeder 81 receives the storage media and moves it toward the interior 85 of the degaussing chamber. Within the interior 85 of the degaussing chamber, the storage media/equipment is subject to the aforementioned magnetic flux, thereby, eliminating the memory stored on the storage media. After degaussing, the belt feeder 81 evacuates the storage media out of a second end 90 of the degaussing chamber and continues to advance the degaussed media/equipment toward a second conveyer 95. In one embodiment, the first end 80 and second end 90 of the degaussing chamber may be equipped with a door or other similar shielding device, to contain the degaussing chamber during use such that the magnetic fields generated therein are relatively confined therewithin.

In a most preferred embodiment, the degausser(s) of the invention is an LM-4 conveyor degausser manufactured by Data Security, Inc. of Lincoln, Nebr. To this end, and in accordance with the above, the degausser(s) 75 of the present invention is a conveyor type degausser with uniform direct current magnetic fields passing along an interior of a degausser cabinet 85 with a magnetic flux density in excess of 10,000 gauss. The LM-4 degausser is equipped with a conveyer belt in accordance with the above such that the degausser may degauss one piece of storage media/equipment per 1-2 seconds, most preferably per 1.5 seconds.

In an alternative embodiment, rather than a conveyer type degausser, the degausser may be a cabinet type degausser, e.g. the HD-6600 cabinet conveyor manufactured by Data Security, Inc. of Lincoln Nebr. To this end, the degausser 75 is adapted to degauss storage media/equipment with units of coercivity of up to 4,200 Oe. In this embodiment, rather than automatically conveying the scrap storage media/equipment, an operator must physically place and lock the storage media/equipment into a degaussing cabinet. The storage media/equipment is then degaussed over approximately a 60 second cycle time. After completion, the operator may remove the degaussed equipment and place it onto the second conveyor 95 in accordance with the above.

The degaussers of the invention are not limited to the foregoing degaussers and may be comprised of any similar degaussers known in the art and in accordance with the teachings above. In a preferred embodiment, but not necessarily limited thereto, the degaussers 75 may be governmentally approved, e.g. approved by the National Security Agency (NSA), for removal of sensitive information. These degaussers may include approved drawer type degaussers, conveyor type degaussers, chamber type degaussers, hand-held type conveyors, single-pass degaussers, and/or dual pass slot degaussers.

The drawer-type degaussers may include the Cambrian model degausser manufactured by Data Devices International of San Marino, Calif.; the Type I, Type HD-2000, Type HD-3000, Type II-A, Type III, APM-10, HPM-4 model degaussers manufactured by Data Security, Inc. of Lincoln, Nebr.; the CF750 and REM-1400NSA model degaussers manufactured by Garner Products or Roseville, Calif.; the ME-RRC3 and ME-RRC3M model degaussers manufactured by Red River Computer of Lebanon, N.H.; and the ME-P3, ME-P3E and ME-P3M model degaussers manufactured by Security Engineered Machinery of Lanham Md.

The conveyor type degaussers may include the 2PTFB15-17, 2PTFB15-18, 2PTFB15-113, and HE15FB-4 model degaussers manufactured by Electro-Matic Products Co. of Chicago, Ill.; the model 2700 degausser manufactured by Garner Products of Roseville, Calif.; the LM-4 model degausser manufactured by Data Security, Inc. of Lincoln Nebr.; and the U5000 model degausser manufactured by Dexter Magnetic Technologies of Hicksville N.Y.

The chamber type degaussers may include degausser models HD-6600 and HD-1T, both manufactured by Data Security, Inc. of Lincoln, Nebr.

The hand held degaussers may including the model AML-6KG degausser manufactured by Applied Magnetic Laboratory, Inc. of Baltimore, Md.; the model 1100 degausser manufactured by Proton Engineering of Palm City, Fla.; the model 1100 degausser manufactured by Security Engineered Machinery of Lanham, Md.; and the model 102-DG degausser manufactured by Whitaker Brothers Business of Rockville, Md.

The single pass slot degausser may include the megnastroyer AML-MS1 degausser manufactured by Applied Magnetic Laboratory, Inc. of Baltimore Md.

Finally, the dual pass slot degaussers may include the 1090 model degausser manufactured by Proton Engineering, Inc. of Palm City, Fla. or the 1090 model degausser manufactured by Security Engineered Machinery of Lanham, Md. The invention is not limited to the foregoing degaussers and may include any similar governmentally approved or non-approved degausser known in the art for erasing the contents of magnetic storage media. In each of these embodiments, the degausser may include a conveyer, where applicable, or may require operator intervention for degaussing. Accordingly, the methods understood in the art for utilizing each of the foregoing degaussers, as defined by the instructions of each degausser, are hereby incorporated by reference.

In another embodiment of the present invention, the trailer 10 may include any combination of the foregoing degaussers or similar degaussers known in the art. These degaussers may be arranged in series such that storage media is passed through each degausser prior to being shred by way of a conveyor system or operator intervention in accordance with the above. Alternatively, the plurality of degaussers may be arranged in conjunction with each other such that multiple storage media may be independently degaussed at the same time. The use of varying degaussers may be based upon the different degaussing requirements of the storage media/equipment such that media/equipment requiring stronger magnetic fields for degaussing, e.g. hard drives, etc. are degaussed using the appropriate degausser and media/equipment requiring weaker magnetic fields, e.g. floppy disks, hard disks, etc. are degaussed using a separate degausser.

Referring again to FIGS. 2 and 4, a second conveyor system 95 is contained within the trailer 10 and is adapted to receive the degaussed media/equipment and transfer it to the shredder 115. The second conveyor system 95 is preferably a flat, belt-feeder type system powered by and in electrical communication with the generator 50. The second conveyor system 95 is comprised of a first end 100 and a second end 105 wherein the belt is adapted to rotate about one or more axis such that the upperside of the conveyer system 95 travels from the first end 100 toward the second end 105. The first end 100 is proximal to the floor 40 of the trailer 10 and may be equipped with one or more ridges 110 to prevent the degaussed storage media or equipment from inadvertently falling from of the second conveyor system 95 to the floor 40. The conveyer system 95 extends from the first end 100 to the second end 105 at an upward angle. Most preferably the conveyer system 95 extends from the first end 100 to the second end 105 at approximately a 45 degree angle such that the second end 105 is proximal to the ceiling 45 of the trailer 10.

Extending over the second end of the second conveyer system 95 is a cover 102. The cover 102 extends from approximately halfway between the first and second ends of the second convey system 95 to the second end 105 of the conveyer system 95. The cover 102 is sized such that the degaussed equipment traveling along the second conveyer system 95 may easily pass between the cover 102 and the second conveyer system 95. However, the cover 102 is close enough to the second conveyer system 95 so as to prevent the degaussed media or equipment from falling from of the second conveyer system as to travels toward the second end 105 of the shredder 115.

In the most preferred embodiment, the second conveyor system 95 is proximate to the conveyer belt 81 of the degausser 75 so as to receive degaussed equipment therefrom. Specifically, as illustrated in FIGS. 4 and 5, the conveyer belt 81 of the degausser 75 extends to overlap with the first end 100 of the second conveyer 95 such that the first end 100 of the second conveyer 95 is proximal to and underneath the conveyer belt 81 of the degausser 75. As illustrated in FIG. 5, degaussed storage media/equipment travels along the belt conveyer 81 to and over the edge of the degausser 75 wherein the degaussed media/equipment is caught by the first end of the second conveyor system 95. The action of rotation of the second belt conveyer system 95, thereby, moves the scrap storage media/equipment from the first end 100 toward and over the second end 105 of the second conveyor system to the shredder 115. The belt may, therefore, be comprised of a tacky, preferably rubber-based, material so as to prevent the degaussed storage media or equipment from sliding down the second conveyor system, as it travels from the first end to the second end.

Based on the foregoing embodiments of the degaussers, the present invention is not limited to the above configuration of the belt conveyer 81 and the second conveyer system 95. In an embodiment of the invention where the degausser does not contain a conveyer belt, an operator may physically remove the degaussed storage media/equipment from the degausser and place it on the second conveyer belt 95 such that it travels to the shredder 115 in accordance with the above. In an even further embodiment, the second conveyer system 95 may be entirely absent from the present invention and an operator places the degaussed equipment directly into the shredder 115.

Regardless of whether the conveyer 95 or an operator is used, once the degaussing is complete, the degaussed storage media or equipment is then placed into the shredder 115. The shredder 115 is preferably comprised of Hammermill-type shredder with a hopper-type casing 120 containing a plurality of hammers or other similar crushing instruments 125, a motor 130, and a frame 135. Referring to FIGS. 4 and 5, in one embodiment, the hopper-type casing 120 is vertically oriented with an opening 121 leading to an internal cavity 122 and, ultimately, a second end 123 wherein both the opening 121 and internal cavity 122 are adapted to receive the degaussed scrap storage media/equipment of the present invention. In accordance with the preferred embodiment described above, the opening 121 may be vertically positioned proximate to and substantially beneath the second end 105 of the second conveyor system such that the opening receives the degaussed storage media/equipment from the second conveyer system 95.

Contained within the internal cavity 122 of the shredder 115 is a rotor 124 containing a plurality of hammers or other similar crushing instruments 125. The rotor 124 is preferably horizontally and rotatably mounted across the internal cavity 122 of the shredder such that the rotor 124 extends across the entire diameter of the cavity 122 and is preferably positioned vertically beneath the opening 121. Extending radially from the rotor 124 so as to substantially fill the internal cavity 122 are a plurality of hammers or crushing instruments 125. The hammers may be pivotally mounted or stationary on the rotor and are adapted to rotate with and in the direction of rotation of the rotor. As illustrated in FIGS. 2 and 3, the hammers or crushing instruments 125 may be offset along the horizontal axis of the rotor 124. The hammers may be comprised of steel, or be another similar metallic instrument, and may be blunt, sharp, or a combination thereof. Based on the foregoing design and orientation within the internal cavity 122 of the shredder, the hammers 125 are adapted to shred the degaussed storage media or equipment as they are rotated with the rotor. More importantly, because of the size of the internal cavity 122, the radial extension of each hammer 125 within the cavity, and the offsetting nature of each hammer 125, the hammers 125 are able to substantially crush and break apart all scrap material inserted into the shredder 115.

The rotor is rotated by way of a motor 130 and one or more belts 131. Specifically, the motor 130 may be any type of motor typically associated with a Hammermill type shredder. Preferably, the motor 130 is comprised of a 30 horsepower motor in electrical communication with generator 50 of trailer 10 using any of the foregoing electrical communication mechanisms discussed above. The belts 131 mechanically couple the motor 130 to the rotor 124 such that the action of the motor 130 and the belts 131 facilitate the rotation of the rotor 124 about its horizontal axis. To this end, the action of the motor 130 and the belts 131 facilitate the rotation of the hammers 125 or other crushing instruments about the longitudinal axis of the rotor such that the shredder may be adapted to shred at least one piece of degaussed media/equipment per 1-2 seconds, preferably one piece per 1.5 seconds.

At a second end 123 of the hopper-type casing 120 is a second opening adapted to receive the shredded storage media/equipment. The second opening of the second end 123 is preferably positioned vertically, directly beneath the rotor 124 so as to receive the shredded material from the internal cavity 122. In a preferred embodiment the walls of the hopper-like casing 120 are slopped toward the second opening of the second end 123 such that material received from the internal cavity 122 is urged or funneled into the second opening.

As illustrated in FIGS. 4 and 5, the hopper-like casing 120, motor 130 and belts 131 are held off the floor of the trailer by a frame 135. More specifically, the frame may be a flat base 132 with a plurality of legs 134 extending to the floor 40 of the trailer 10. The flat base 132 may support the hopper-like casing 120 and the motor such that the motor 130 is affixed within a specific proximity to the rotor 124 wherein the fixed proximity may be of any distance understood in the art for a motor to facilitate the rotary motion of a rotor. Most importantly, the frame 135 holds the hopper-like casing 120 off of the ground such that the second end 123 of the casing 120 is accessible and the shredded material passing therethrough may be received by a conveyor system, discussed below.

Based on the foregoing design, degaussed material from a conveyor type degausser is received into the first opening 121 of the hopper-like casing 120. The material then passes into the internal cavity 122 of the casing 120 where the rotation of the rotor 124 and the plurality of offsetting crushing instruments 125 completely shred the storage media/equipment such that it is no longer usable. The shredded material is then received by the second end 123 of the casing 120 and ultimately passes through the second opening.

The above embodiment of the vertically oriented shredder is not intended to be limiting to the this invention. Rather, in accordance with the various degaussers contemplated herein, the orientation of the shredder may be changed based upon the type of degausser. In embodiments of the invention where the second conveyor is used, the shredder is preferably oriented in accordance with the above. However, in embodiments where there is no second conveyer and an operator is required to move the degaussed materials from the degausser to the shredder, the shredder may be horizontally oriented or in any other orientation that facilitates the deposit of the degaussed material therein, while not hindering the ability of the shredder to physically destroy the storage media/equipment.

In each of the above described embodiments of a shredder, the shredded material is received through the second end 123 of the hopper by a third conveying system 140 wherein the third conveying system conveys the shredded scrap media/equipment to one or more of a plurality of receptacles 145. In one preferred embodiment, the third conveying system 140 is vacuum driven system that is powered by a motor (not illustrated) in electrical communication with the generator 50. More specifically, the conveying system 140 contains a vacuum source contained within or juxtaposed to a canister 150 within the interior of the trailer 10 and remote from the shredder. The vacuum source is in electrical communication with the generator 50 and in fluid communication with the shredder 115, preferably, by way of one or more ducts 155. To this end, the vacuum source provides a suction force through the ducts 155 so as to remove the shredded material from the internal cavity 122 of the casing. As illustrated in FIG. 5, the shredded material is, thereby, suctioned through the duct 155 and into the canister 150 of the vacuum source. Once in the vacuum source, the shredded material may be deposited within one or a plurality of receptacles 145.

In a most preferred embodiment, the vacuum source 150 is comprised of a cyclone-type device. More specifically, the vacuum source creates a cyclone-type force generating enough suction force to draw the shredded material from the shredder 115, along the duct 155 and into the conically shaped canister 150. Once within the chamber 150, the heavier shredded material falls through the chamber and into a receptacle 145 therebelow. With lighter, airborne material however, the cyclone-type force vacuum source prevents these materials from falling into the receptacle 145. Rather, the tangential forces associated with the cyclone-type force urge these materials toward the top of the canister 150 and into an air filter duct 160 leading to an air filtration system 165.

The air filtration system 165 is comprised of at least one, preferably two, air filter containers 170 vertically mounted over a canister 175. Referring to FIGS. 4 and 5, the two air filter containers 170 are vertically oriented, cylindrical columns that are adapted to be vertically mounted. Each container 170 is cylindrically shaped with a hollowed lumen passing therethrough. The annular wall forming the cylindrical shape is preferably comprised of a porous or mesh screen with one or more air filters lining an interior side of the screen. The air filters may be comprised of any air filter known in the art. Preferably, however, the air filters are adapted to prevent the passage of particles greater than 0.5 microns therethrough. Accordingly, air passing through the mesh screen is relatively free of any particles greater than 0.5 microns in size.

In one embodiment, one end of each air filter container 170 is bound to an end of the adjacent filter container, preferably by an adhesive foam ring 180 or other similar bonding agent. To this end, the lumen of the air filter containers are in fluid communication. Coupled to one end of the connected air filter containers 170 is a hollow canister 175. The hollow canister 175 is cylindrically shaped with a diameter equivalent to those of the air filter containers 170 and at least one opening at one end of the canister 175. The canister is sealing mounted to one end of the connected air filter containers 170 by way of an adhesive foam ring 180 or other similar bonding agent.

The air filtration duct 160 is coupled to the other open end of the connected air filter containers 170 such that the duct is placed into fluid communication with the containers 170 and canister 175. Specifically, the air filtration duct 160 is connected to the air filtration system by a connection means (not illustrated). This connection means may be any type of connection means known in the art for securing a duct or hose to an air filtration system. For example, in one embodiment the connection means my be a connection fitting adapted to be concentrically mounted over both the duct/hose and the open end of the air filter container 170. The connection means is, therefore, adapted to sealing by couple the air filtration duct 160 with the air filter container 170 such that the duct 160 and the containers 170 are in fluid communication with each other.

Based on the foregoing, air containing lighter, airborne particles is filtered through the containers 170. As noted above, the tangential forces associated with the cyclone-type forces of the vacuum source urge the lighter, airborne pieces of the shredded media/equipment toward the top of the vacuum source 150. These tangential forces then urge the particle-containing air into the air filter duct 160 leading to the air filtration system 165. As air passes from the duct and into the vertically oriented containers 170, it is forced through the air filters of each containers and out the porous screen walls of the containers 170. All particles greater than 0.5 microns in size, however, are caught by the air filters and retained within the containers 170. Thus, the air exhausted from the containers 170 is relatively free of the airborne particles. These particles either remain trapped within the air filters or, for larger particles, are allowed to fall into the canister 175. Periodically, the air filters or canister may be changed such that these particles are removed from the containers 170 and canister 175 and a fresh air filter and canister may be utilized.

In a most preferred embodiment, the third conveying system 140, including the air filtration system 165 is comprised of Tempest S-Series Cyclone Dust Collection System manufactured by PSI Woodworking Products of Philadelphia, Pa. To this end, the third conveying system 140 and the air filtration system 165 may include each of the foregoing embodiments as well as the parts associated with the apparatus and design of the Tempest S-series vacuum system.

Referring again to FIGS. 2 and 4, the receptacle 145 mounted beneath the vacuum source container 150 may be removably mounted thereunder. More specifically, in one embodiment, a track system 185 may be positioned underneath the vacuum source. The track system 185 may be comprised of two rails 186 fixably mounted to the floor 40 of the trailer such that each rail is parallel to the other. Extending perpendicularly between the rails is a plurality of rotatably mounted rollers 187 adapted to continuously rotate in both a clockwise and counterclockwise direction. In this configuration, the receptacle is adapted to slide along the rollers into position beneath the vacuum source container 150. Moreover, the receptacle, once full, may be removed from underneath the vacuum source container 150 by simply sliding the receptacle 145 along the rollers.

The method of removably mounting the receptacle is not limited to the track system 185. In one embodiment, the underside of the receptacle may contain a removably mounted cart, or the like, wherein the receptacle may be slid underneath the vacuum source container 150 with relative ease and locked into place thereunder. To this end, the present invention may also include similar embodiments of removable or removably mounted trash receptacles, as known or understood by one of ordinary skill in the art.

In a further embodiment of the present invention the receptacles 145 may be raised and lowered from the trailer 10 by a lift mechanism (not illustrated). Specifically, the receptacles 145 are difficult to remove from the trailer 10 when full. Accordingly, a lift mechanism may be provided on an exterior of the trailer 10 to facilitate the removal. In one embodiment, the lift is coupled to the open end 25 of the trailer, or doorway 65 in alternative embodiments, such that the receptacle may be raised and lowered to the ground from the trailer 10. The lift may be a hydraulic lift, pneumatic lift, mechanical lift, or any type of lift apparatus commonly associated with providing and/or removing heavy materials from a truck bed or trailer.

Referring to FIGS. 6 and 7, mounted within the interior and on the exterior of the trailer 10 is a video and/or audio surveillance system. The video system is comprised of a plurality of surveillance video cameras 190 mounted on both an external side and an internal side of the trailer 10. FIG. 6 illustrates that the cameras 190 may be positioned on the trailer 10 at least at each interior and exterior corner of the trailer 10. The present invention, however, is not limited to the placement of the cameras 190 in any particular location. Rather, cameras 190 may be placed in any location on the interior or exterior of the trailer 10. Most preferably, the cameras 190 are placed throughout the trailer 10 such that the entire interior and the area immediately surrounding the perimeter of the trailer 10 is constantly monitored. The video system, in one embodiment, is adapted to record the happenings within and immediately surrounding the trailer by one or more video recording systems contained within the camera or linked to a video recording system contained within the trailer 10. To this end, the interior and exterior of the trailer 10 may be monitored and recorded at all times during both operation and non-operation of the trailer. Alternatively, the video recording systems may be remote from the trailer 10. To this end, the content captured from each of the plurality of cameras 190 is sent to a remote location wherein the interior and the exterior of the trailer 10 may be monitored and recorded at all times during both operation and non-operation of the trailer. Such a remote location may be “on-site” or within the facility where the trailer 10 is located or “off-site” at a location remote from both the trailer 10 and the facility where the trailer 10 is located.

The trailer 10 may also be equipped with sound recording devices (not illustrated). More specifically, the audio devices may record sounds made within the interior of the trailer 10 and sounds made in the area immediately surrounding the exterior of the trailer 10. To this end, the sound recording device may be any type of sound recording device known in the art for surveillance recordings. In one embodiment, the sound recording device may be apart from the cameras 190. In an alternative embodiment, the sound recording devices may be integral with the cameras 190. In a further embodiment, the audio devices may be linked to an audio recording system contained within the trailer 10 such that the audio recording system at all times monitors and records the interior and exterior of the trailer 10 during both operation and non-operation of the trailer. Alternatively, the audio recording system may be remote from the trailer 10. To this end, the content captured from each of the plurality of audio recording devices is sent to a remote location wherein the interior and exterior of the trailer 10 where it may be monitored and recorded at all times during both operation and non-operation of the trailer. Such a remote location may be “on-site” or within the facility where the trailer 10 is located or “off-site” at a location remote from both the trailer 10 and the facility where the trailer 10 is located.

The trailer 10 of the invention may further include an alarm system. More specifically, the alarm system may be comprised of any alarm system known in the art to secure a protected area and prevent unauthorized personnel from entering or tampering with the area. The alarm of the invention may be comprised of an alarm system that sounds an audible alarm at the trailer 10 and/or at a remote location to signify the happening of a signaling event. Alternatively, the alarm system may send an electrical signal within the trailer 10 or to a remote location from the trailer 10 to signify the happening of a signaling event. These signaling events may include motion at or near the exterior of the trailer 10, motion at or near the interior of the trailer 10, equipment failure, inappropriate personnel within the trailer 10, inappropriate personnel about the trailer 10, or manual activation. To this end, the alarm may be selectively deactivated during operational use of the trailer and activated during non-operation of the trailer 10.

In operation, the vehicle of the invention, exemplified as a tractor trailer above, may be provided to a facility in need of “on-site” storage media/equipment destruction. Specifically, the vehicle may be mobilized to the desired “on-site” location and the storage media/equipment designated for destruction provided to the vehicle without leaving the facility. The media/equipment may then be provided into the interior of the vehicle, such as the trailer 10 in the exemplified embodiment above. Referring to FIGS. 3 and 5, an operator may begin to disassemble the larger equipment at the workbench 195, where necessary, such that the larger equipment is disassembled. Once disassembled, the storage media is placed in to the degausser 75. In the embodiment where in the degausser 75 contains a conveyer belt 81, the storage media/equipment is placed on the conveyer belt 81 wherein it is automatically passed through the degausser 75. The degaussed storage media or equipment then exits the degausser 75, by way of the second end 90 of the degausser wherein it travels along the conveyor belt 81 to the second conveyor system 95. The degaussed storage media/equipment is then moved along the second conveyor system 95 from the first end 100 to and over the second end 105 of the conveyor 95 and into the shredder 115.

In other embodiments where the degausser 75 does not contain a conveyer belt, the storage media is placed directly into the degausser 75. Once the degausser 75 completes a cycle of operation and erases the memory of the storage media/equipment, the operator may remove the degaussed media/equipment and either place it onto the second conveyor system 95 in accordance with the above or place it directly into the shredder 115. With the later embodiment, the orientation of the shredder 115 is preferably such that the operator can easily provide the degaussed media or equipment therein, without injury or damage to the equipment.

Regardless of how it arrives there, the degaussed media or equipment passes through the first opening 121 and into the interior cavity 122 of the shredder 115. The degaussed media is then shredded by the action of the crushing instruments 125 rotating about the rotor. The shredded material then passes through the remainder of the internal cavity 122 of the shredder towards and through the second end 123 of the shredder 115

Shredded material from the shredder 115 is then received by the third conveying system 140. Specifically, the shredded material is suctioned through one or more ducts 155 by a vacuum force. The vacuum force creates enough suction force to draw the shredded material from the shredder 115, along the duct 155 and into a conically shaped chamber 150. Once within the chamber 150, the heavier shredded material falls through the chamber and into a receptacle 145 therebelow. With lighter, airborne material however, the, preferably, cyclone-type forces associated with the vacuum source prevent these materials from falling into the receptacle 145. Rather, the tangential forces associated with the cyclone-type vacuum source redirect these materials toward the top of the chamber 150 and into an air filter duct 160 leading to an air filtration system 165. In the air filtration system 165, the air is filtered through a plurality of air filters adapted to retain therein any particles greater than 0.5 microns in size. In other words, the lighter, airborne material is contained within the air filtration system such that air exhausted from the vacuum system is substantially free from airborne shredded media/equipment.

The receptacle 145 receives the shredded media/equipment until it is full. At that point, an operator may remove the receptacle 145 from its position beneath the vacuum container 150 and may replace the full receptacle with an empty one. The full receptacle may then be removed from the vehicle, preferably by way of a lift associated with the vehicle, such that the shredded media/equipment may be properly disposed.

In a further embodiment, the foregoing operations within the vehicle and activity outside of the vehicle may be monitored and/or recorded by the video and/or audio surveillance systems. To this end, an operator within the vehicle or from a remote location may ensure that the foregoing operations are properly performed and that the storage media/equipment is properly disposed. Moreover, the alarm system of the invention may ensure that the contents of the vehicle, to include non-degaussed storage media/equipment, are properly protected from tampering or theft by unauthorized personnel.

Based on the foregoing, the invention is advantageous because it provides a central and mobile location for conveniently and completely destroying magnetically stored data and physical hardware without potentially compromising the confidentiality of the data stored thereon. More specifically, the vehicle of the invention provides an apparatus that may be mobilized from one location to another such that the vehicle may provide “on-site” destruction of targeted storage media/equipment. To this end, the vehicle of the invention may travel to the location or facility desiring destruction of particular storage media/equipment and may destroy the media/equipment utilizing the methods discussed above. Thus, the present invention eliminates any risk associated with transporting the memory containing storage media/equipment to an “off-site” facility for destruction. Moreover, the present invention provides a convenient and cost effective mechanism to dispose of unwanted storage media/equipment.

The following is claimed:

1) Mobile apparatus for destroying scrap electronic and electrical equipment and media at selected dispersed sites, comprising:
a) vehicle adapted for highway travel and having an enclosed openable bed as a part thereof;
b) an electrical generator mounted on the vehicle;
c) at least one degausser mounted within the bed, in electrical communication with the generator and providing electromagnetic flux if preselected strength based upon the nature and level of sensitivity of any information that had been stored or handled by the now-scrapped electronic and electrical equipment, to destroy such information; and
d) a shredder for shredding the degaussed scrap electronic and electrical equipment and media, mounted within the bed of the vehicle and in electrical communication with the generator.

2) Apparatus of claim 1 wherein the vehicle is a tractor trailer.

3) Apparatus of claim 1 further comprising a workbench mounted within the bed of the vehicle wherein the workbench facilitates worker disassembly of scrap electronic and electrical equipment and media, as needed, prior to degaussing and/or shredding.

4) Apparatus of claim 1 wherein the electrical generator is a 480 volt, 3 phase generator.

5) Apparatus of claim 1 wherein the electrical generator is a 40 kilowatt generator.

6) Apparatus of claim 1 wherein degausser(s) are adapted to completely erase the magnetically stored memory of the scrapped electronic and electrical equipment and media.

7) Apparatus of claim 6 wherein the degausser(s) are adapted to completely degauss the scrapped electronic and electrical equipment and media at a rate of one piece of equipment per 1.5 seconds.

8) Apparatus of claim 1 wherein a feeder belt carries the scrapped electronic and electrical equipment and media through the degausser(s).

9) Apparatus of claim 1 wherein the degausser is selected from a group consisting of an LM-4 Degausser, an HD-6600 Degausser, a Type I Degausser, and combinations thereof.

10) Apparatus of claim 1 wherein the shredder receives scrap electronic and electrical media from the degausser(s) after degaussing is complete, by way of a conveyor system.

11) Apparatus of claim 1 wherein the shredder is a Hammermill-type shredder.

12) Apparatus of claim 1 wherein the shredder shreds scrap electronic and electrical equipment and media at a rate of one piece of equipment per 1.5 seconds.

13) Apparatus of claim 1 wherein the receptacle is removably mounted on the vehicle for replacement by other receptacles.

14) Apparatus of claim 1 further comprising an assembly for conveying shredded scrap electronic and electrical equipment and media from the shredder to at least one selected receptacle.

15) Apparatus of claim 14 wherein the conveyor is in electrical communication with the generator.

16) Apparatus of claim 14 wherein the conveyor is vacuum driven by a motor such that the motor and an associated vane generates enough negative pressure to draw the shredded scrap electronic and electrical equipment and media from the shredder to the receptacle.

17) Apparatus of claim 16 wherein the motor generates pressure through a cyclone-type vacuum force that draws the shredded scrap electronic and electrical equipment and media into a conical chamber wherein larger scrap particles are dropped into the at least one selected receptacle and lighter particles are redirected, by way of a duct system, to an air filtration system.

18) Apparatus of claim 17 wherein the filtration system filters air containing the lighter particles such that air exiting the conveyer system is substantially free of particles greater than 0.5 microns in size.

19) Apparatus of claim 1 further comprising a lift system for selectably lifting or lowering one or more of the receptacles between the vehicle and ground.

20) Apparatus of claim 19 wherein the lift system is selected from the group consisting of a hydraulic lift system, a pneumatic lift system, and a mechanical lift system.

21) Apparatus of claim 1 further comprising an video surveillance system within the enclosed openable bed to optically record activity within the enclosed bed.

22) Apparatus of claim 1 further comprising an audio surveillance system within the enclosed openable bed to audibly record activity with in the enclosed bed.

23) Apparatus of claim 1 further comprising a video surveillance system and an audio surveillance system within the enclosed openable bed to record activity within the enclosed bed.

24) Apparatus of claim 1 further comprising an video surveillance system on an exterior surface the vehicle to record activity outside of the vehicle.

25) Apparatus of claim 1 further comprising an audio surveillance system on an exterior surface the vehicle to record activity outside the vehicle.

26) Apparatus of claim 1 further comprising a video surveillance system and an audio surveillance system on an exterior surface the vehicle to record activity outside the vehicle.

27) Apparatus of claim 1 further comprising an alarm system mounted on the vehicle wherein the alarm system sends an alarm signal during a signaling event.

28) The mobile apparatus of claim 27 wherein the alarm signal is an audible signal.

29) Apparatus of claim 27 wherein the alarm signal is sent to an remote location.

30) Apparatus of claim 27 wherein the alarm signal is electronic.

31) Apparatus of claim 27 wherein the signaling event is selected from the group consisting of manual activation, unauthorized motion within the bed of the vehicle, unauthorized motion in the area immediately outside of the vehicle; equipment failure; unauthorized personnel within the vehicle; and unauthorized personnel around an exterior of the vehicle.

32) A process for destroying scrap electronic and electrical equipment and media at selected geographically separated sites, comprising:
a) providing a vehicle that is adapted for highway travel and has an enclosed openable bed as a part thereof; with an electrical generator mounted on the vehicle; at least one degausser, for degaussing electronic and electrical equipment and media, mounted within the bed and in electrical communication with the generator; at least one shredder, mounted within the bed wherein the shredder is in electrical communication with the generator and receives scrap electronic and electrical media from the at least one degausser after degaussing is complete;
b) feeding scrap electronic and electrical equipment and media into the at least one degausser;
c) degaussing the electronic and electrical equipment and media;
d) feeding the degaussed electronic and electrical equipment into the shredder; and
e) shredding the degaussed electronic and electrical equipment and media.

33) The process of claim 32 wherein the degaussing of the electronic and electrical equipment occurs at a rate of one piece of equipment per 1.5 seconds.

34) The process of claim 32 wherein a feeder belt automatically feeds the scrap electronic and electrical equipment and media into the degausser(s).

35) The process of claim 32 wherein a feeder belt automatically feeds the scrap electronic and electrical equipment and media through the degausser(s).

36) The process of claim 32 wherein the shredding of the scrap electronic and electrical equipment and media occurs at a rate of one piece of equipment per 1.5 seconds.

37) The process of claim 32 further comprising conveying the shredded electronic and electrical equipment and media to at least one selected receptacle.

38) The process of claim 37 wherein the shredded electronic and electrical equipment and media is conveyed to the at least one selected receptacle by way of a vacuum driven conveyor assembly.

39) The process of claim 37 further comprising removing the receptacle when full.

40) The process of claim 37 further comprising separating larger scrap particles from lighter scrap particles wherein larger scrap particles are dropped into the at least one selected receptacle and lighter particles are redirected, by way of a duct system, to an air filtration system.

41) The process of claim 40 further comprising filtering the air containing the lighter scrap particles through an air filtration system such that air exiting the system is free of substantially all of the scrap electronic and electrical equipment and media greater than 0.5 microns in size.

42) The process of claim 32 further comprising monitoring by video surveillance the enclosed openable bed to record activity within the enclosed bed.

43) The process of claim 32 further comprising monitoring by audio surveillance system the enclosed openable bed to record activity within the enclosed bed.

44) The process of claim 32 further comprising monitoring by video surveillance and audio surveillance system the enclosed openable bed to record activity within the enclosed bed.

45) The process of claim 32 further comprising monitoring by video surveillance system an exterior surface the vehicle to record activity outside of the vehicle.

46) The process of claim 32 further comprising monitoring by audio surveillance system an exterior surface the vehicle to record activity outside of the vehicle.

47) The process of claim 32 further comprising monitoring by video surveillance system and audio surveillance system an exterior surface the vehicle to record activity outside of the vehicle.

48) The process of claim 32 further comprising an sending an alarm signal from an alarm system mounted on the vehicle wherein the alarm signal is sent during a signaling event.

49) The process of claim 48 wherein the alarm signal is an audible signal.

50) The process of claim 48 wherein the alarm signal is sent to an remote location.

51) The process of claim 47 wherein the alarm signal is electronic.

52) The process of claim 48 wherein the signaling event is an event selected from the group consisting of manual activation, unauthorized motion within the bed of the vehicle, unauthorized motion in the area immediately outside of the vehicle; equipment failure; unauthorized personnel within the vehicle; and unauthorized personnel around an exterior of the vehicle.

53) A process for destroying scrap electronic and electrical equipment and media at selected geographically separated sites, comprising:
a) providing a vehicle that is adapted for highway travel and has an enclosed openable bed as a part thereof, with an electrical generator mounted on the vehicle; at least one degausser for degaussing electronic and electrical equipment and media mounted within the bed and in electrical communication with the generator; at least one shredder, mounted within the bed wherein the shredder is in electrical communication with the generator and receives scrap electronic and electrical media from the at least one degausser after degaussing is complete;
b) feeding scrap electronic and electrical equipment and media into the at least one degausser;
c) degaussing the electronic and electrical equipment and media;
d) feeding the degaussed electronic and electrical equipment into the shredder;
e) shredding the degaussed electronic and electrical equipment and media;
f) conveying the shredded scrap electronic and electrical equipment and media from the shredder to at least one selected receptacle wherein the receptacle is removably mounted on the vehicle;
g) recording activity within the enclosed bed by a first video and audio recorder system mounted on the vehicle; and
h) sending a signal from an alarm system mounted on the vehicle wherein the signal is sent in response to occurrence of a signaling event selected from the group consisting of manual activation, unauthorized motion within the bed of the vehicle, unauthorized motion in the area immediately outside of the vehicle; equipment failure; unauthorized personnel within the vehicle; and unauthorized personnel around an exterior of the vehicle; upon completion of the degaussing and shredding of electronic and electrical equipment and media at that site, moving the vehicle to a secured site where degaussing and shredding of electrical and electric equipment and media is required.

54) Mobile apparatus for destroying scrap electronic and electrical equipment and media at selected sites, comprising:
a) a vehicle adapted for highway travel and having an enclosed openable bed as a part thereof;
b) an electrical generator mounted on the vehicle;
c) at least one degausser mounted within the bed and in electrical communication with the generator and being capable of prosuxing electromagnetic flux that of a preselected level based upon the nature and level of sensitivity of any information that had been stored or handled by the now-scrapped electronic and electrical equipment;
d) a first conveyer system mounted within the at least one degausser wherein the conveyer system automatically feeds the scrap electronic and electrical equipment and media into and through the degausser;
e) a shredder for shredding the scrap electronic and electrical equipment and media that is mounted within the bed of the vehicle and is in electrical communication with the generator, wherein the shredder receives scrap electronic and electrical media from the degausser(s) after degaussing is complete, by way of a second conveyor system; and
f) a receptacle removably mounted on the vehicle for receiving shredded scrap electronic and electrical equipment and media from the shredder.

55) Mobile apparatus for destroying scrap electronic and electrical equipment and media at selected sites, comprising:
a) a vehicle adapted for highway travel and having an enclosed openable bed as a part thereof;
b) an electrical generator mounted on the vehicle;
c) at least one degausser mounted within the bed and in electrical communication with the generator and being capable of producing an electromagnetic flux that is of preselected strength, based upon the nature and level of sensitivity of any information that had been stored or handled by the scrap electronic and electrical equipment, to destroy any electric information encoded on such scrap electronic and electrical equipment;
d) a first conveyer system mounted within the at least one degausser wherein the conveyer system automatically feeds the scrap electronic and electrical equipment and media into and through the degausser;
e) a shredder for shredding the scrap electronic and electrical equipment and media that is mounted within the bed of the vehicle and is in electrical communication with the generator, wherein the shredder receives scrap electronic and electrical media from the degausser(s) after degaussing is complete, by way of a second conveyor system.
f) a receptacle removably mounted on the vehicle wherein the receptacle receives shredded scrap electronic and electrical equipment and media from the shredder; and
g) a vacuum driven conveyor that separates lighter shredded electronic and electrical equipment and media from heavy shredded electronic and electrical equipment and media and conveys the heavy shredded electronic and electrical equipment and media into the receptacle from the shredder and conveys the light shredded electronic and electrical equipment and media to an air filtration system.

56) A mobile apparatus for destroying scrap electronic and electrical equipment and media at selected sites, comprising:
a) a vehicle adapted for highway travel and having an enclosed openable bed as a part thereof;
b) an electrical generator mounted on the vehicle;
c) at least one degausser mounted within the bed and in electrical communication with the generator and being of an electromagnetic flux that is preselected based upon the nature and level of sensitivity of any information that had been stored or handled by the now-scrapped electronic and electrical equipment;
d) a first conveyer system mounted within the at least one degausser wherein the conveyer system automatically feeds the scrap electronic and electrical equipment and media into and through the degausser;
e) a shredder for shredding the scrap electronic and electrical equipment and media that is mounted within the bed of the vehicle and is in electrical communication with the generator, wherein the shredder receives scrap electronic and electrical media from the degausser(s) after degaussing is complete, by way of a second conveyor system.
f) a receptacle removably mounted on the vehicle wherein the receptacle receives shredded scrap electronic and electrical equipment and media from the shredder;
g) a vacuum driven conveyor that separates lighter shredded electronic and electrical equipment and media from heavy shredded electronic and electrical equipment and media and conveys the heavy shredded electronic and electrical equipment and media into the receptacle from the shredder and conveys the light shredded electronic and electrical equipment and media to an air filtration system;
h) a video and audio surveillance system mounted within the enclosed bed;
i) a video and audio surveillance system mounted on an exterior of the vehicle; and
j) an alarm system mounted on the vehicle wherein the alarm system sends an alarm signal during a signaling event selected from the group consisting of manual activation, unauthorized motion within the bed of the vehicle, unauthorized motion in the area immediately outside of the vehicle; equipment failure; unauthorized personnel within the vehicle; and unauthorized personnel around an exterior of the vehicle.
